(19) United States
(12) Patent Application Publication
(10) Pub. No.: US 2019/0362294 A1
(43) Pub. Date: Nov. 28, 2019

(54) SYSTEMS AND COMPUTER-IMPLEMENTED METHODS FOR DYNAMIC AND AUTOMATIC RESOURCE MANAGEMENT

(71) Applicant: The Fin Exploration Company, San Francisco, CA (US)

(72) Inventors: Ben Vishny, Winnetka, IL (US); Tiffany Citra, San Francisco, CA (US); John Graham, San Francisco, CA (US)

(21) Appl. No.: 16/172,669

(22) Filed: Oct. 26, 2018

Related U.S. Application Data
(60) Provisional application No. 62/676,214, filed on May 24, 2018.

(51) Int. Cl. G06Q 10/06

(52) U.S. Cl. CPC G06Q 10/063116; G06Q 10/06313; G06Q 10/0639; G06Q 10/063112

(57) ABSTRACT

Methods and systems for dynamic and automatic allocation of resources are provided. One of the methods includes: generating multiple task performance agendas, where each task performance agenda describes a particular assignment of each task in a set of tasks to an agent in a group of agents; for each task performance agenda, (1) generating a task performance utility, (2) generating an agent satisfaction utility, and (3) determining an aggregate utility for the task performance agenda based, at least in part, on the task performance utility and the agent satisfaction utility for the task performance agenda; selecting a preferred task performance agenda from the multiple task performance agendas based, at least in part, on the aggregate utility for the selected task performance agenda; and assigning the set of tasks to the group of agents in accordance with the selected task performance agenda.

### CROSS-REFERENCE TO RELATED APPLICATIONS

This application claims the benefit under 35 U.S.C. § 119(e) of the filing date of U.S. Patent Application No. 62/676,214, for “systems and computer-implemented methods for dynamic and automatic resource management,” which was filed on May 24, 2018 and which is incorporated here by reference.

### FIELD

This specification relates to dynamic (e.g., real-time or near real-time) and automatic management of resources such as computational resources to complete tasks.

### BACKGROUND

Systems such as virtual personal assistant systems can employ both computational resources and human agents to respond to requests sent to the system by a user. Such systems operate under constantly changing conditions and have a variety of metrics to satisfy.

### SUMMARY

This specification relates to dynamic and automatic allocation of resources such as computational resources to complete tasks. The dynamic and automatic allocation of computational resources can occur in real-time or near real-time

Enclosed are methods, systems, and computer program products for generating a set of agendas for the performance of tasks by agents of a management system, such as a virtual assistant management system. These technologies also involve selecting a preferred agenda from the set of agendas based, at least in part, on a task performance utility and an agent satisfaction utility, and to allocating tasks to be performed by the agents of the management system according to the preferred agenda.

In general, one innovative aspect of the subject matter described in this specification can be embodied in methods that include the actions of: generating multiple task performance agendas, where each task performance agenda of the multiple task performance agendas describes a particular assignment of each task in the set of tasks to an agent in the group of agents; for each task performance agenda, (1) generating a task performance utility, the task performance utility for the task performance agenda being a measure of utility of performing the set of tasks according to the task performance agenda, (2) generating an agent satisfaction utility, the agent satisfaction utility being a measure of agent satisfaction with the assignment of each task in the set of tasks to the agent described by the task performance agenda, and (3) determining an aggregate utility for the task performance agenda based, at least in part, on the task performance utility and the agent satisfaction utility for the task performance agenda; selecting a preferred task performance agenda from the multiple task performance agendas based, at least in part, on the aggregate utility for the selected task performance agenda; and assigning the set of tasks to the group of agents in accordance with the selected task performance agenda.

The method can further include obtaining data describing an original group of agents; wherein generating multiple task performance agendas comprises a) obtaining data describing a new agent subsequent to obtaining data describing the original group of agents and b) generating multiple task performance agendas based at least in part on the data describing the new agent.

The method can further include obtaining data describing an original set of tasks; wherein generating multiple task performance agendas comprises a) obtaining data describing a new task subsequent to obtaining data describing the original set of tasks and b) generating multiple task performance agendas based at least in part on the data describing the new task.

Generating a task performance utility for a task performance agenda can include: obtaining data about each task in the set of tasks; for each task, (1) generating an estimated time of performance if the task performance agenda is adopted, and (2) generating a measure of utility for the task at the estimated time of performance for the task; and generating the task performance utility for the task performance agenda based on each measure of utility.

Generating an agent satisfaction for a task performance agenda can include: for each agent in a group of agents, (1) obtaining a desired schedule for the agent, (2) generating a schedule for the agent if the task performance agenda is adopted, and (3) generating a measure of deviation between the desired schedule for the agent and the generated schedule for the agent; and generating the agent satisfaction utility for the task performance agenda based on each measure of deviation.

The method can further include allocating a standby time period into the estimated schedule for the agent; receiving an urgent task during the standby time period; and assigning the urgent task to the agent, in response to receiving the urgent task during the standby time period.

Another innovative aspect of the subject matter described in this specification can be embodied in a system that includes: a task reception engine configured to receive an actual task; a hypothetical task generation engine configured to generate a hypothetical task; an agenda generation engine configured to receive the actual task from the task reception engine and the hypothetical task from the hypothetical task generation engine and generate a task performance agendas in response to the actual task and the hypothetical task, a task performance agenda being an assignment of the actual task and the hypothetical tasks to at least one agent; an agent scheduling engine configured to receive a desired schedule, the desired schedule corresponding to an agent; a utility estimation engine configured to receive a task performance agendas from the agenda generation engine and a desired schedule from the agent scheduling engine and wherein the utility estimation engine includes: (1) a task performance engine configured to generate a task performance utility based, at least in part, on the task performance agenda, and (2) an agent satisfaction utility configured to generate an agent satisfaction utility based, at least in part, on the task performance agendas and the desired schedule, and wherein the utility estimation engine is configured to determine an aggregate utility based at least in part on the task performance utility and the agent satisfaction utility; and an agenda selection engine configured to choose a task performance agenda from multiple task performance agendas based, at least in part, on the aggregate utility.

The subject matter described in this specification can be implemented in particular embodiments so as to realize one or more of the following advantages.

Resource management systems described in this specification allow for dynamic and automatic allocation of computational resources to complete real world tasks. The dynamic allocation of computation resources can happen in real-time or near real-time and can adjust to a changing portfolio of tasks and a changing portfolio of agent schedule requests.

A virtual personal assistant system can allocate tasks to human agents of the system to generate efficient schedules. The virtual personal assistant system can also allocate a standby time period into a schedule of an agent. If the system receives an urgent request during the standby time for an agent, the system can assign the urgent request to the agent, allowing the system to quickly and efficiently allocate urgent requests. The virtual personal assistant system can also detect when an upcoming set of tasks will require more agents than are currently scheduled to work on the set of tasks. In response, the virtual personal assistant system can preemptively suggest alternative shift schedules to ensure that the system will be adequately staffed to complete the upcoming set of tasks.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating one example of a system for allocating resources including scheduling work for human agents.

FIG. 2 is a flow diagram of an exemplary process for assigning a set of tasks to a group of agents.

FIG. 3 is a flow diagram of an exemplary process for generating a task performance utility for a task performance agenda.

FIG. 4 is a flow diagram of an exemplary process for generating an agent satisfaction utility for a task performance agenda.

FIG. 5 is a graph illustrating the growth of system metrics over a week.

FIG. 6 is a schedule tree that depicts a set of potential schedules for an agent.

FIG. 7 is a depiction of an example process for selecting a schedule.

Like reference numbers denote like components.

### DETAILED DESCRIPTION

A virtual personal assistant system can receive, from a user, a request that involves one or more tasks to be completed by one or more agents of the virtual personal assistant system to respond to the request. For example, the request can be a request for information, such as “What movies are playing in nearby theaters this weekend?” In response to this request, the system can determine one or more tasks to be completed to respond to the request, such as accessing the user's location, identifying theaters close to the user's location, and determining the movies playing at the identified theaters. An additional task could be to make a recommendation for which movie of the identified movies the requester should see.

After determining the tasks, the system can generate multiple task performance agendas, each agenda describing a particular assignment of each of the determined tasks to one or more agents. Some of the task performance agendas may allocate time or computing resources more efficiently. The system can generate a task performance utility based on an agenda. Some of the task performance agendas may be more favorable to human agents than other agendas. Therefore, in addition to the task performance utility, the system can also generate an agent satisfaction utility. Using both of these utilities, the system can select a preferred agenda.

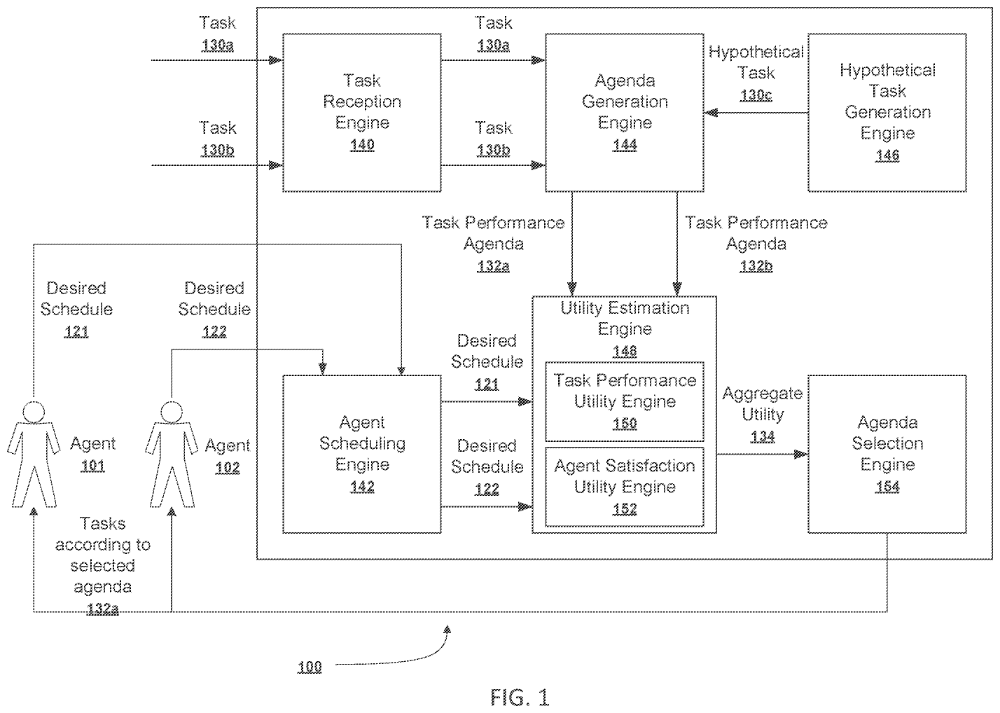

FIG. 1 is a block diagram of one example of a virtual personal assistant system 100. FIG. 1 shows a first agent 101 and a second agent 102. The agents 101 and 102 can each send a desired schedule 121 and 122, respectively, to an agent scheduling engine 142 of the virtual personal assistant system 100. In addition to receiving the desired schedules 121 and 122, the virtual personal assistant system 100 can also receive a task 130a and a task 130b. Although not shown in FIG. 1, the tasks 130a and 130b can be generated by a component configured to receive a user request, determine tasks that correspond to the user request, and communicate the determined tasks to a task reception engine 140 of the virtual personal assistant system 100.

The task reception engine 140 is configured to receive tasks and process the received tasks. For example, the task reception engine 140 can organize the received tasks according to data related to the task. The data related to the task can include an estimated amount of time needed to perform a particular task or a deadline or priority associated with the task. After organizing the received tasks, the task reception engine 140 can also store the tasks in a database of tasks. The task reception engine 140 can also send the tasks 130a and 130b to an agenda generation engine 144.

The agenda generation engine 144 can receive the tasks 130a and 130b and generate multiple task performance agendas. Each task performance agenda can represent a unique assignment of tasks to agents of the virtual personal assistant system 100. Each task performance agenda can also indicate a time and date for each task to be completed. In the example of FIG. 1, the agenda generation engine 144 receives tasks 130a and 130b and generates a first task performance agenda 132a and a second task performance agenda 132b.

In some implementations, the agenda generation engine 144 can receive one or more hypothetical tasks from a hypothetical task generation engine 146. A hypothetical task can be a task that the virtual personal assistant system 100 is not required to perform, e.g., because it is not associated with a user request as are the tasks 130a and 130b. In the example of FIG. 1, the hypothetical task generation engine 146 generates a hypothetical task 130c. The agenda generation engine 144 can use a hypothetical task, such as the hypothetical task 130c, to generate a task performance agenda that accounts for a task that the virtual personal assistant system 100 may see in the future. For example, the hypothetical task generation engine 146 can predict that a particular request will likely be received in the future. In response to this prediction, the hypothetical task generation engine can generate one or more hypothetical tasks that may correspond to the predicted request.

The virtual personal assistant system can also include a utility estimation engine 148 that is configured to receive task performance agendas, such as the task performance agendas 132a and 132. The utility estimation engine 148 can also include a task performance utility engine 150 that can use the received task performance agendas to generate a task performance utility for each task performance agenda. The task performance utility can be a measure of utility of completing the task performance agenda, i.e., performing the set of tasks according to a task performance agenda.

The task performance utility engine 150 can take into account a variety of characteristics of the task performance agenda to generate a task performance utility. For example, the task performance utility engine 150 can generate the task performance utility based in part on the computing resources required to perform the task performance agenda. For example, the task performance utility engine 150 may assign a higher task performance utility to a task performance agenda that assigns computationally expensive tasks to multiple agents, when compared to a task performance agenda that assigns those tasks all to one agent.

As another example, the task performance utility engine 150 can generate the task performance utility based in part on the time required to perform the tasks according to the task performance agenda. For example, the task performance utility engine 150 may assign a higher task performance utility to an agenda that schedules certain tasks earlier than other tasks (e.g., if those certain tasks have a deadline or preferred time of completion associated with them), when compared to an agenda that does not schedule those certain tasks before other tasks. The deadline or preferred time of completion associated with a task can be submitted to the virtual personal assistant system 100 by a user of the system. The deadline can also be determined by the virtual personal assistant system 100. For example, the task reception engine 140 can determine that a first task is a prerequisite for a second task and assign a deadline to the first task. The deadline can indicate that that the first task should be performed prior to the second task.

In addition to receiving the task performance agendas 132a and 132b, the utility estimation engine 148 can also receive the desired schedules 121 and 122 from the agent scheduling engine 142. The utility estimation engine 148 can include an agent satisfaction utility engine 152 that can use desired schedules to generate an agent satisfaction utility. The agent satisfaction utility for an agent can be a measure of agent satisfaction with the assignment of tasks to agents as specified by a task performance agenda.

The agent satisfaction utility engine 152 can determine a degree of similarity between the assignment of tasks described by a task performance agenda, and that described by a desired schedule.

The desired schedule can indicate desired features such as the agent's desired time off and the agent's daily work schedule (e.g., start time, lunch time, meeting time, end time, etc.). Other features of an agent's desired schedule can include one or more tasks that the agent prefers to perform or one or more agents with whom the agent in question prefers to work. The agent satisfaction utility engine 152 can use these features when determining an agent satisfaction utility.

In some implementations, the agent satisfaction utility engine 152 can use, in part, desired schedules received by the virtual personal assistant system 100 in the past, to determine the agent satisfaction utility. In some implementations, the agent satisfaction utility is a linear combination of (1) The result of an exponential time decay function that depends on agent past preference outcomes and (2) Agent desired work schedule for the currently scheduled period, e.g., week.

The agent satisfaction utility engine can also make judgements on behalf of the agent—for example, when changing from one shift schedule to another, whether to switch the agent to their preferred shift schedule in a way that results in less sleep between shifts, or to choose a less ideal schedule because the agent should never get less than 8 hours sleep between shifts.

For example, the agent satisfaction utility engine 152 can determine that the virtual personal assistant system 100 has recently assigned an agent one or more task performance agendas with less than a threshold amount of agent satisfaction utility resulting in a potentially dissatisfied agent. In response, the agent satisfaction utility engine 152 can boost the computed agent satisfaction utility by the perceived amount of inconvenience the agent has borne in the past with a time decay function.

The utility estimation engine 148 can use the task performance utility and the agent satisfaction utility to generate an aggregate utility 134. In the example of FIG. 1, the utility estimation engine receives the task performance agendas 132a and 132b and the desired schedules 121 and 122 and generates an aggregate utility 134. In some implementations, the aggregate utility 134 is generated by calculating a weighted average of the normalized task performance utility and agent satisfaction utility. For example, the combination can be an addition of the weighted normalized utilities. Please note that although it is not shown in FIG. 1, the utility estimation engine 148 can generate more than one aggregate utility.

In some implementations, the aggregate utility function can be based at least in part on a loss function associated with a particular agenda or schedule as follows:

L=[(f1−h), (f2−h), max (0, h−f3)]*[w1, w2, w3]

where w1-w3 are weights, h is the total available hours for one or more agents, and [f1, f2, f3] would be [number of cut-off hours, number of preferred hours, number of work hours coming in].

In some implementations, an agent can assign a weight to various features to indicate which features should be given a higher priority when the virtual personal assistant system 100 generates an agent satisfaction utility for an agenda. For example, the virtual personal assistant system 100 can allocate a fixed number of points to an agent, who can then allocate the points to features that the agent finds to be most important in determining their agent satisfaction utility.

After determining the aggregate utility 134, the utility estimation engine 148 can send the aggregate utility to an agenda selection engine 154. The agenda selection engine 154 can use the aggregate utility to choose a preferred task performance agenda from the task performance agendas 132a or 132b. The agenda selection engine 154 can then communicate the preferred task performance agenda to the agents of the virtual personal assistant system 100. In the example of FIG. 1, the agenda selection engine 154 receives the aggregate utility 134, determines that the preferred task performance agenda is the first task performance agenda 132a, and communicates the selection to the agents 101 and 102.

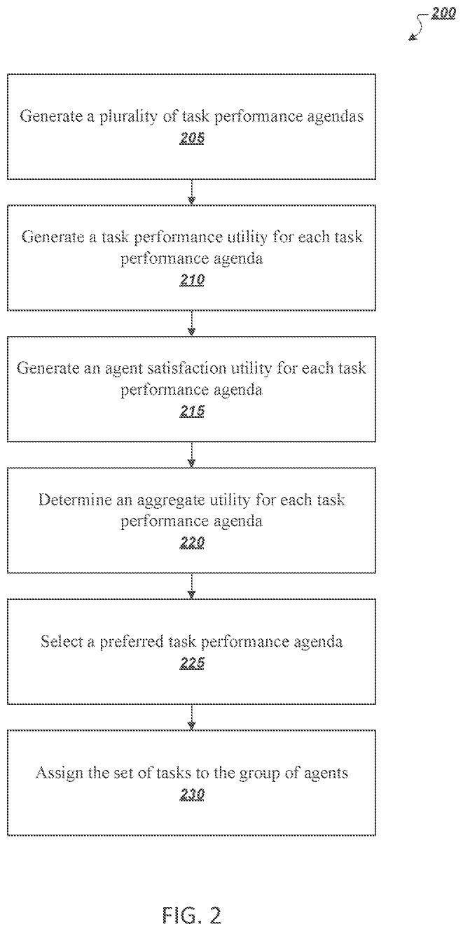

FIG. 2 is a flow diagram of a process for scheduling a set of tasks to be performed by a group of agents. The process can be completed by a management system such as the virtual personal assistant system 100.

The system generates a set of task performance agendas, where each task performance agenda in the set of task performance agendas describes a particular assignment of each task in a set of tasks to an agent in a group of agents (205). Each agent can be assigned multiple tasks. The set of task performance agendas can include each possible assignment of the tasks to the agents. The task performance agendas can also describe the time by which an agent assigned a task should begin the task.

In some implementations, the system obtains data describing an original group of agents. The data describing the original group of agents can include a desired schedule for each of the agents, including information about when each agent starts and ends the workday. The data can include historical data about the tasks that each agent worked on, or expressed a desire to work on, in the past and the tasks that each agent was actually assigned according to past task performance agendas. The system can obtain data describing a new agent subsequent to obtaining data describing the original group of agents and use this new agent data, in part, to revise one or more task performance agendas.

In addition to obtaining data describing an original group of agents, the system can also obtain data describing an original set of tasks. After obtaining the data describing the original set of tasks, the system can obtain data that describes a new task and use this data, in part, to revise one or more task performance agendas.

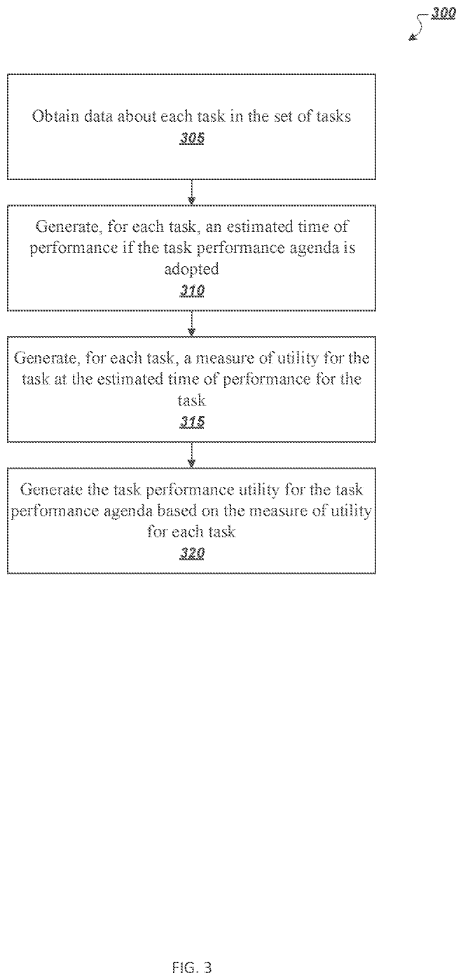

The system generates, for each task performance agenda, a task performance utility, the task performance utility for the task performance agenda being a measure of utility of performing the set of tasks according to the task performance agenda (210). An example process for generating the task performance utility for a task performance agenda is described with regard to FIG. 3.

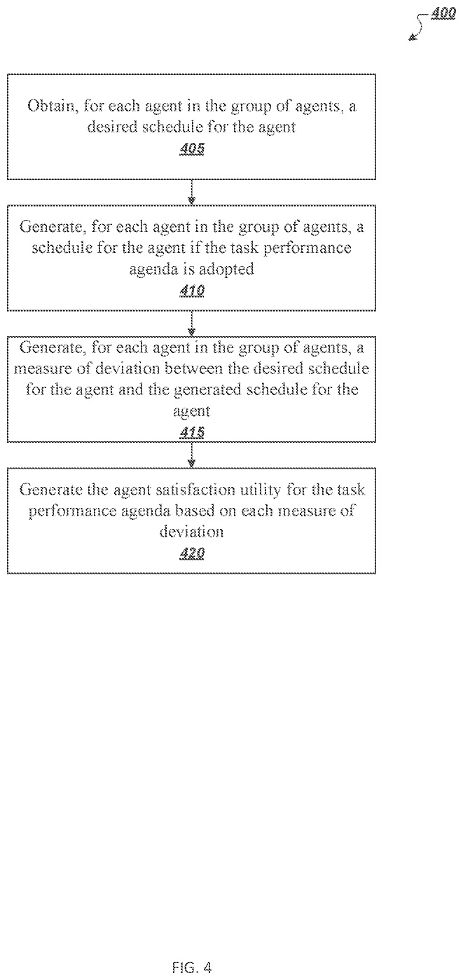

The system generates, for each task performance agenda, an agent satisfaction utility, the agent satisfaction utility being a measure of agent satisfaction with the assignment of each task in the set of tasks to the agent described by the task performance agenda (215). An example process for generating the agent satisfaction utility for a task performance agenda is described with regard to FIG. 4.

The system determines, for each task performance agenda, an aggregate utility for the task performance agenda based, at least in part, on the task performance utility and the agent satisfaction utility for the task performance agenda (220).

The system selects a preferred task performance agenda from the multiple task performance agendas based, at least in part, on the aggregate utility for the selected task performance agenda (225). The system can select the task performance agenda with the highest aggregate utility.

The system assigns the set of tasks to the group of agents in accordance with the selected task performance agenda (230).

FIG. 3 is a flow chart of an example process for generating a task performance utility for a task performance agenda. The example process can be performed by a management system, such as the virtual personal assistant system 100.

The system obtains data about each task in the set of tasks (305). The data can include a user request associated with each task, the time that the user request was received by the system, a deadline or preferred time of completion associated with the user request or the individual tasks of the set of tasks, and an estimated amount of time that each task will take to perform.

The system generates, for each task, an estimated time of performance if the task performance agenda is adopted (310). The system can generate a data structure that describes the order and duration of each task to be performed according to the task performance agenda.

The system generates, for each task, a measure of utility for the task at the estimated time of performance for the task (315). The system can use the data obtained in stage 305 to determine the measure of utility for each of the tasks. For example, if the estimated time of performance for the task is after the deadline associated with the task, the system can generate a low measure of utility for the task, to indicate that the task would not be performed before its deadline, if the task performance agenda is adopted.

The system generates the task performance utility for the task performance agenda based on each measure of utility (320). In one implementation, the system can compute the average of each measure of utility and generate the task performance utility based on the average.

For example, the task performance utility can be calculated using the loss function:

L=[f1−h, f2−h, max (0, h−f3)]*[w1, w2, w3]

The features, f1, f2, and f3, can be cut off hours, preferred work hours, and total added work hours, respectively, while the values of the features can be 1, 2, and 3 hours, respectively. The weights, w1, w2, and w3 can be determined by the virtual personal assistant system according to a measure of importance assigned to each of the three features. In this example, the virtual personal assistant system can assign w1, w2, and w3 to be 5, 10, and 20, respectively. The total available agent hours, h, is determined by the most optimal schedule. Scheduling an agent that has one available hour increments h from zero to one hour. If multiple agents were scheduled, the value of h would equal the sum of the available hours for each of the multiple agents.

According to the above example, when an agent is scheduled for one hour, the value of the loss function is:

L=[(1−1)*5+(2−1)*10+max(0, 1−3)*20]=0+10+0=10 hours

When no agent is scheduled, the value of the loss function is:

L=[(1−0)*5+(2−0)*10+max (0, 0−3)*20]=5+20+0=25 hours

The virtual personal assistant system schedules agents in a way that minimizes loss. Therefore, the virtual personal assistant system would schedule the agent for one hour (L=10 hours) instead of not scheduling the agent (L=25).

The system can determine the weights noted above based on historical data, e.g., the system can predict for some number of missed cut-off and preferred hours, some percentage loss of users or agents. Similarly the system can determine a percentage decrease in system utility for every hour of overstaffed agents.

FIG. 4 is a flow chart of an example process for generating an agent satisfaction utility for a task performance agenda. The example process can be performed by a management system, such as the virtual personal assistant system 100.

The system obtains, for each agent in the group of agents, a desired schedule for the agent (405).

The system generates, for each agent in the group of agents, a schedule for the agent if the task performance agenda is adopted (410). In some implementations, the system can detect a generated schedule that requires an agent to perform tasks at a time when the desired schedule of the agent indicates that the agent is unavailable (e.g., if the agent is sick or on vacation, or if the required work time is out of the range of working hours for the agent). In response to the detection, the system can eliminate the schedule from consideration.

The system generates, for each agent in the group of agents, a measure of deviation between the desired schedule for the agent and the generated schedule for the agent (415). The measure of deviation between the desired schedule and the generated schedule can include information related to whether the generated schedule requires the agent to perform tasks at a time when the desired schedule of the agent indicates that the agent is available, but has a preference towards working at another time. For example, if a generated schedule requires the agent to perform a task during a time that the desired schedule of the agent indicates that the agent prefers not to work, the system can generate a high measure of deviation to indicate that the generated schedule may not be compatible with the desired schedule.

The system generates the agent satisfaction utility for the task performance agenda based on each measure of deviation (420). The system can compute an average measure of deviation for the agents of the group of agents associated with a particular task performance agenda. The system can then compute the agent satisfaction utility from the average measure of deviation for the agents. For example, a high average measure of deviation for the agents may indicate that most or all of the desired schedules of the agents are not compatible with their respective generated schedules. In this example, a high average measure of deviation corresponds to a low agent satisfaction utility.

The system can be configured to continuously receive user requests. A user request can have an urgency associated with it, for example, if a user requires the system to complete a request within a short time from when the system receives the user request. Accordingly, the system can denote tasks associated with urgent user requests as being urgent tasks. In some implementations, the system can preemptively allocate time for urgent tasks to be performed. For example, the system can allocate a standby time period into the estimated schedule for an agent. If the system receives an urgent task during the standby time period, then the system can assign the urgent task to the agent. Assigning the urgent task to the agent can allow the system to respond to the urgent task in a timely manner.

In some implementations, the system can determine that an upcoming set of tasks to be completed requires more agents than the currently adopted work schedule provides. In response, ahead of the upcoming set of tasks, the system can suggest one or more alternative shift schedules to one or more agents to preempt a possible scheduling deficiency.

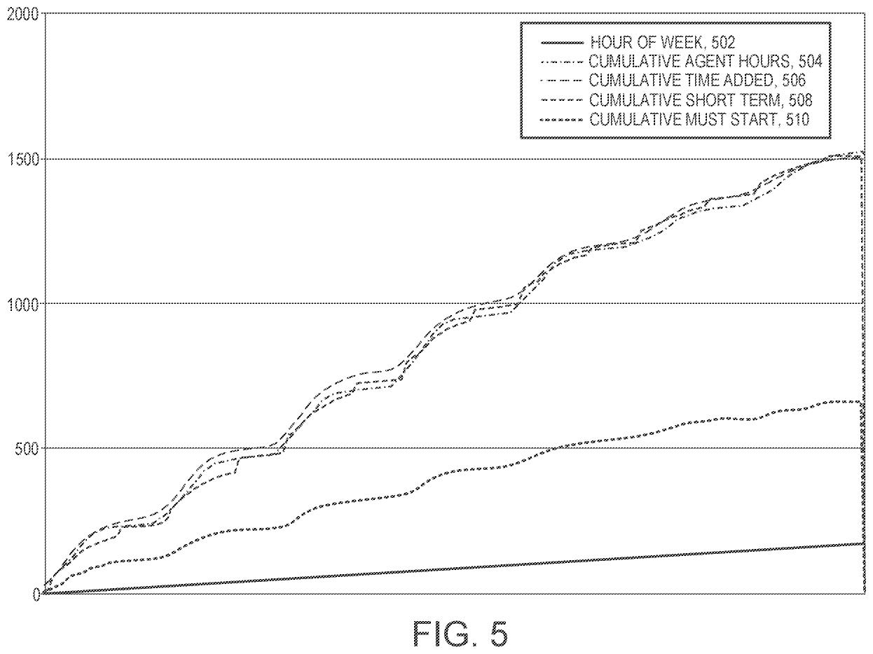

FIG. 5 is a graph 500 illustrating the growth of system metrics over a week. The graph 500 includes an hour of the week curve 502, a cumulative agent hour curve 504, a cumulative time added curve 506, a cumulative short term curve 508, and a cumulative must start curve 510. This graph illustrates a time evolution of some of the demands placed on a resource management system such as a virtual personal assistant system.

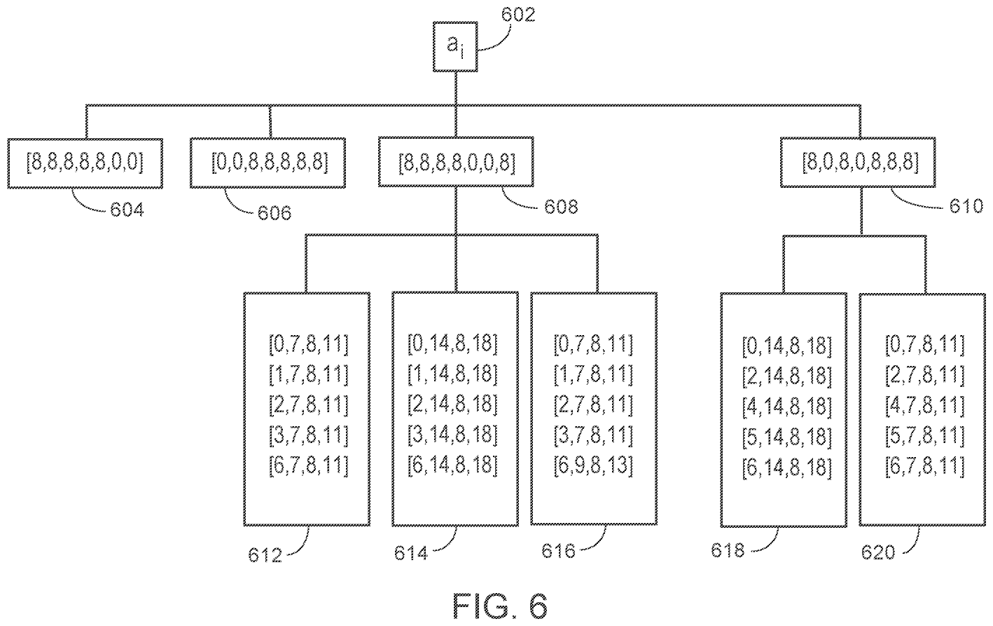

FIG. 6 is a schedule tree 600 that depicts a set of potential schedules for an agent interacting with the system of FIG. 1. The schedule tree 600 includes an agent identifier 602, shown as aᵢ, in FIG. 6. The agent identifier 602 can include a unique agent identification number i. The schedule tree 600 can also include possible days arrays 604, 606, 608, and 610. Each possible days array 604-610 can be an array of size seven, where each element of the array corresponds to a day of the week. The values of the possible days array 604-610 can include 0, 8, and 10 for the number of hours worked in that particular day. Each of the possible days arrays 604-610 can have a set of child arrays that represent a set of permutations of physically possible days, or simply, set of permutations. The schedule tree 600 includes a set of permutation arrays 612, 614, and 616, each set being a child of the possible days array 608. Each array in the set of child arrays can have a number of elements. As illustrated each array in the set of child arrays has 4 elements where the elements represent day of the week, start hour, shift duration, and lunch hour respectively. The schedule tree 600 also includes a set of permutation arrays 618 and 620, each set being a child of the possible days array 610.

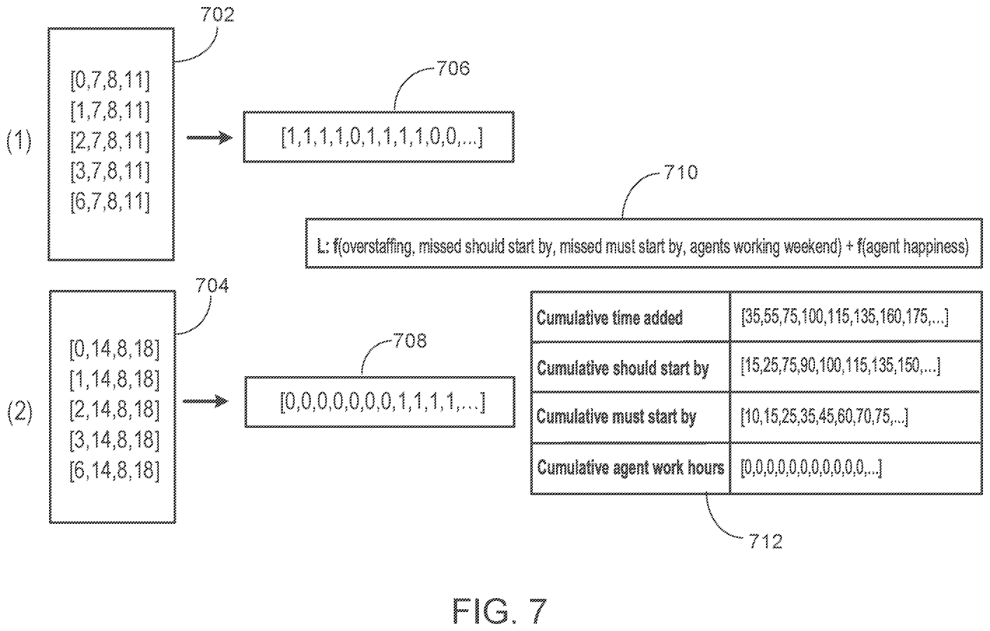

FIG. 7 is a depiction of an example process 700 for selecting a schedule that reduces the value returned by a loss function 710. Each of the sets of permutations 702 and 704 can be converted to an hour vector. The set of permutations 612 is converted to an available hour vector 706, while the set of permutations 614 is converted to an available hour vector 708. The available hour vectors 706 and 708 represent the time that the corresponding agent is available at a particular point in time, e.g., the value of each index of the available hour vectors 706 and 708 can be input to the loss function as the variable h. The loss function 710 can operate on a set of system data including data reflecting a potential work schedule. More specifically, the loss function 710 can be a function of overstaffing, missed soft deadlines, missed hard deadlines and number of missed agent requests. The loss function 710 can also take into account a metric of prior agent happiness. More generally, the loss function 710 can reflect a) capacity loss, e.g., a measure of performance effectiveness related to choosing a particular task performance agenda, b) agent satisfaction loss, e.g., a measure of agent satisfaction related to choosing a particular task performance agenda, c) a combination of capacity loss and agent satisfaction loss, or d) a combination of capacity loss and agent satisfaction loss plus other factors. The process 700 illustrates the sets of permutations 702 and 704 (which could be the sets of permutations 612 and 614 from FIG. 6). Table 712 shows various feature vectors. The leftmost column of table 712 corresponds to a description of a feature vector, while the rightmost column shows the feature vector that corresponds to the description. As described above, the virtual personal assistant system 100 uses the feature vectors, in part, to calculate the value of the loss function at a certain time. Stated differently, 712 represents various feature vectors for various times (t =timesteps in hours) that the system uses to determine the loss associated for a particular t (i.e., the loss function 710). Each column is the feature vector for one t.

706 and 708 are the agent work hour features associated with a set of valid schedules. In the illustrated case the cumulative agent work hours for these two agents if one were to display it in table 712 would be [1, 1, 1, 1, 0, 1, 1, 1, 2, 2, . . . ] and, in one example, the goal is to find the set of hour vectors and associated schedules that minimizes the loss function.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous. More specifically, a system described in this specification can use multitasking if the system is processing such a large number of agents and possible task performance agendas that the system cannot compute the most optimal solution with one computational process. A system described in this specification could shard the agent pool so that more orderings of agents can get computed for each agent pool. A system described in this specification could place agents that are complementary in a grouping so that the agents are more likely to get their preferred schedule.

What is claimed is:

1. A computer implemented method for assigning a set of tasks to a group of agents, the method comprising:
generating a plurality of task performance agendas, where each task performance agenda in the plurality of task performance agendas describes a particular assignment of tasks in the set of tasks to an agent in the group of agents;
for a task performance agenda in the plurality of task performance agendas,
generating a task performance utility, the task performance utility for the task performance agenda being a measure of utility of performing the set of tasks according to the task performance agenda,
generating an agent satisfaction utility, the agent satisfaction utility being a measure of agent satisfaction with the assignment of tasks in the set of tasks to the agent described by the task performance agenda, and
determining an aggregate utility for the task performance agenda based, at least in part, on the task performance utility and the agent satisfaction utility for the task performance agenda;
selecting a task performance agenda from the plurality of task performance agendas based, at least in part, on the aggregate utility for the selected task performance agenda; and
assigning the set of tasks to the group of agents in accordance with the selected task performance agenda.

2. The method of claim 1, wherein the method further comprises obtaining data describing an original group of agents, wherein generating a plurality of task performance agendas comprises:
obtaining data describing a new agent subsequent to obtaining data describing the original group of agents; and
generating a plurality of task performance agendas based at least in part on the data describing the new agent.

3. The method of claim 1, wherein the method further comprises obtaining data describing an original set of tasks, wherein generating a plurality of task performance agendas comprises:
obtaining data describing a new task subsequent to obtaining data describing the original set of tasks; and
generating the plurality of task performance agendas based at least in part on the data describing the new task.

4. The method of claim 1, wherein generating the task performance utility for a task performance agenda comprises:
obtaining task data for tasks in the set of tasks;
for an individual task,
generating an estimated time of performance if the task performance agenda is adopted, and
generating a measure of an individual task performance utility for the task at the estimated time of performance for the task; and
generating an aggregate task performance utility for the task performance agenda based at least in part on measures of individual task performance utilities.

5. The method of claim 1, wherein generating the agent satisfaction utility for a task performance agenda comprises:
for each agent in the group of agents,
obtaining a desired schedule for the agent,
generating a schedule for the agent if the task performance agenda is adopted, and
generating a measure of deviation between the desired schedule for the agent and the generated schedule for the agent; and
generating the agent satisfaction utility for the task performance agenda based at least in part on each measure of deviation.

6. The method of claim 5 further comprising:
allocating a standby time period into a schedule for the agent;
receiving an urgent task during the standby time period; and
assigning the urgent task to the agent during the standby time period in response to receiving the urgent task.

7. A system comprising:
one or more computers and one or more storage devices on which are stored instructions that are operable, when executed by the one or more computers, to cause the one or more computers to perform operations:
a task reception engine operable to receive an actual task;
a hypothetical task generation engine operable to generate a hypothetical task;
an agenda generation engine operable to receive the actual task from the task reception engine and the hypothetical task from the hypothetical task generation engine and generate a task performance agendas in response to the actual task and the hypothetical task, a task performance agenda being an assignment of the actual task and the hypothetical tasks to at least one agent;
an agent scheduling engine operable to receive a desired schedule, the desired schedule corresponding to an agent;
a utility estimation engine operable to receive a task performance agenda from the agenda generation engine and a desired schedule from the agent scheduling engine and wherein the utility estimation engine comprises:
a task performance engine operable to generate a task performance utility based, at least in part, on the task performance agenda, and
an agent satisfaction utility operable to generate an agent satisfaction utility based, at least in part, on the task performance agenda and the desired schedule,
wherein the utility estimation engine is operable to determine an aggregate utility based at least in part on the task performance utility and the agent satisfaction utility; and
an agenda selection engine operable to choose a task performance agenda from a plurality of task performance agendas based, at least in part, on the aggregate utility.

8. The system of claim 7, wherein the operations comprise obtaining data describing an original group of agents, and generating a plurality of task performance agendas further comprising:
obtaining data describing a new agent subsequent to obtaining data describing the original group of agents; and
generating a plurality of task performance agendas based at least in part on the data describing the new agent.

9. The system of claim 7, wherein the operations comprise obtaining data describing an original set of tasks and generating a plurality of task performance agendas further comprising:
obtaining data describing a new task subsequent to obtaining data describing the original set of tasks; and
generating a plurality of task performance agendas based at least in part on the data describing the new task.

10. The system of claim 7, wherein the operations comprise generating a task performance utility for a task performance agenda further comprising:
obtaining task data for tasks in the set of tasks;
for an individual task,
generating an estimated time of performance if the task performance agenda is adopted, and
generating a measure of an individual task performance utility for the task at the estimated time of performance for the task; and
generating an aggregate task performance utility for the task performance agenda based at least in part on measures of individual task performance utilities.

11. The system of claim 7, wherein the operations comprise generating agent satisfaction utility for a task performance agenda further comprising:
for an agent in the group of agents,
obtaining a desired schedule for the agent,
generating a schedule for the agent if the task performance agenda is adopted, and
generating a measure of deviation between the desired schedule for the agent and the generated schedule for the agent; and
generating the agent satisfaction utility for the task performance agenda based at least in part on each measure of deviation.

12. The system of claim 11, wherein the operations further comprise:
allocating a standby time period into a schedule for the agent;
receiving an urgent task during the standby time period; and
assigning the urgent task to the agent during the standby time period in response to receiving the urgent task.

13. A system comprising:
one or more computers and one or more storage devices on which are stored instructions that are operable, when executed by the one or more computers, to cause the one or more computers to perform operations comprising:
generating a plurality of task performance agendas, where each task performance agenda in the plurality of task performance agendas describes a particular assignment of tasks in a set of tasks to an agent in a group of agents;
for a task performance agenda in the plurality of task performance agenda,
generating a task performance utility, the task performance utility for the task performance agenda being a measure of utility of performing the set of tasks according to the task performance agenda,
generating an agent satisfaction utility, the agent satisfaction utility being a measure of agent satisfaction with the assignment of tasks in the set of tasks to the agent described by the task performance agenda, and
determining an aggregate utility for the task performance agenda based, at least in part, on the task performance utility and the agent satisfaction utility for the task performance agenda;
selecting a task performance agenda from the plurality of task performance agendas based, at least in part, on the aggregate utility for the selected task performance agenda; and
assigning the set of tasks to the group of agents in accordance with the selected task performance agenda.

14. The system of claim 13, wherein the operations further comprise obtaining data describing an original group of agents, and wherein generating a plurality of task performance agendas comprises:
obtaining data describing a new agent subsequent to obtaining data describing the original group of agents; and
generating a plurality of task performance agendas based at least in part on the data describing the new agent.

15. The system of claim 13, wherein the operations further comprise obtaining data describing an original set of tasks, and wherein generating a plurality of task performance agendas comprises:
obtaining data describing a new task subsequent to obtaining data describing the original set of tasks; and
generating a plurality of task performance agendas based at least in part on the data describing the new task.

16. The method of claim 13, wherein generating the task performance utility for a task performance agenda comprises:
obtaining task data about tasks in the set of tasks;
for an individual task,
generating an estimated time of performance if the task performance agenda is adopted, and
generating a measure of an individual task performance utility for the task at the estimated time of performance for the task; and
generating an aggregate task performance utility for the task performance agenda based at least in part on measures of individual task performance utilities.

17. The system of claim 13, wherein generating the agent satisfaction utility for a task performance agenda comprises:
for each agent in the group of agents,
obtaining a desired schedule for the agent,
generating a schedule for the agent if the task performance agenda is adopted, and
generating a measure of deviation between the desired schedule for the agent and the generated schedule for the agent; and
generating the agent satisfaction utility for the task performance agenda based at least in part on each measure of deviation.

18. The system of claim 17, wherein the operations further comprise:
allocating a standby time period into a schedule for the agent;
receiving an urgent task during the standby time period; and
assigning the urgent task to the agent, in response to receiving the urgent task during the standby time period.

19. The system of claim 13, wherein the operations further comprise:
receiving a hypothetical task from a hypothetical task generation engine; and
generating a task performance agenda that accounts for a task that the system receives after the system has selected a task performance agenda.

20. The system of claim 13, wherein the operations further comprise;
receiving task data, the task data including at least one of an estimated amount of time to complete a type of task, a task deadline and a task priority.
